(19) United States
(12) Patent Application Publication
(10) Pub. No.: US 2022/0259011 A1
(43) Pub. Date: Aug. 18, 2022

(54) IMPROVEMENTS IN OR RELATING TO STAIRLIFTS

(71) Applicant: Stannah Stairlifts Limited, Hampshire (GB)

(72) Inventor: Andreas Csaba Szentistvany, Hampshire (GB)

(21) Appl. No.: 17/625,878

(22) PCT Filed: Jul. 7, 2020
(86) PCT No.: PCT/GB2020/051624

§ 371 Date: Jan. 10, 2022

(30) Foreign Application Priority Data
Jul. 9, 2019 (GB) 1909850.8

(51) Int. Cl. B66B 9/08

(52) U.S. Cl. CPC B66B 9/0823; B66B 9/0846

(57) ABSTRACT

A compact screw drive stairlift has the drive screw retained in a cavity within the rail and engages drive transfer elements extending along an inner surface of the cavity. The combined configurations of the screw and the rail ensure that the stairlift carriage is retained on the rail.

### CROSS-REFERENCE TO RELATED APPLICATIONS

This application is the U.S. National Stage of PCT/GB2020/051624 filed Jul. 7, 2020, which claims priority to United Kingdom Patent Application No. 1909850.8 filed Jul. 9, 2019, the content of both of which are incorporated herein by reference in their entirety.

### FIELD OF THE INVENTION

This invention relates to a stairlift and more particularly, though not necessarily solely, to a straight stairlift.

### BACKGROUND TO THE INVENTION

Stairlifts are installed in buildings, typically homes, to enable persons with impaired mobility to access different levels in the buildings. A general requirement of all stairlifts is that they are reliable and safe. Conventionally stairlifts employ a rack and pinion drive and, while safe and reliable, this form of drive requires separate lubrication that can cause an undesirable mess. Further, ride and pinion drives can exhibit poor ride quality, particularly when crossing joints in the rail, and this problem tends to increase with increasing carriage speed.

In addition to issues concerning the drive, there is a need to make stairlifts as compact as possible with the least possible intrusion into the staircase so that able-bodied persons can use the staircase with minimum interference.

It is an object of the invention to provide a stairlift which will go at least some way in addressing the aforementioned problems; or which will at least provide a novel and useful choice.

### SUMMARY OF THE INVENTION

Accordingly, in one aspect, the invention provides a stairlift including a rail having a length direction; a carriage mounted on said rail for movement along said rail in said length direction; a chair or load carrier mounted on said carriage; and a drive mechanism comprising inter-engaging drive elements on said carriage and rail respectively configured and operable to drive said carriage along said rail, wherein said rail has an internal cavity extending along said length direction axis; an aperture extending along said rail providing access to said cavity, said carriage overlying part of said aperture and projecting through said aperture such that said drive elements are located entirely within said cavity.

Preferably the rail is configured such that said aperture provides sole means of access to said cavity.

Preferably said aperture is located at an upper margin of said rail when the stairlift is in an operating state.

Preferably said rail has a base and sides extending upwardly from said base, said aperture being defined between upper edges of said sides.

Preferably said aperture has a length dimension extending along the length direction of said rail, and a width dimension, said carriage having a width dimension greater than the width dimension of said aperture and overlying part of said aperture.

Preferably said drive mechanism is configured to retain said carriage in engagement with said rail.

Preferably said drive mechanism comprises a worm screw mounted on said carriage and arranged for rotation about an axis parallel to the length direction of said rail; and drive transfer elements fixed to said rail and extending into said cavity to engage said worm screw.

Preferably said drive transfer elements are arranged in a line along a base of said cavity.

Preferably said worm screw has an axial length L₁ and the spacing between adjacent drive transfer elements is a substantially constant L₂ wherein L₂ is less than L₁.

Preferably, when viewed in a vertical cross-section along said length direction, said worm screw has a circular periphery and said cavity, at least in part, is defined by a circular wall within said rail, clearance being provided between said circular wall and said worm screw.

Preferably at least some of said drive transfer elements include a bearing engagable with said worm screw and arranged to rotate about an axis perpendicular to an axis of rotation of said worm screw.

Preferably said worm screw is rotatably supported between end caps, said end caps being further configured to provide sliding support for said carriage within said rail.

Preferably said worm screw is formed from a plastics material.

Preferably said rail is defined by a plurality of rail segments held together in series along said length direction.

Preferably each of said rail segments is substantially identical.

Many variations in the way the present invention can be performed will present themselves to those skilled in the art. The description which follows is intended as an illustration only of one means of performing the invention and the lack of description of variants or equivalents should not be regarded as limiting. Subject to the scope of the appended claims, wherever possible, a description of a specific element should be deemed to include any and all equivalents thereof whether in existence now or in the future.

### BRIEF DESCRIPTION OF THE DRAWINGS

One working embodiment of the invention will now be described with reference to the accompanying drawings in which:

FIG. 1: shows an isometric view of a stairlift according to the invention;

FIG. 2: shows a side elevation of the carriage forming part of the stairlift shown in FIG. 1;

FIG. 3: shows an end elevation, partly in cross-section, of the stairlift shown in FIG. 1;

FIG. 4: shows a horizontal longitudinal cross-section of the stairlift shown in FIG. 1;

FIG. 5: shows an enlarged end view of part of an assembly shown in FIG. 4; and

FIG. 6: shows the components of FIG. 5 separated and one of the components reversed.

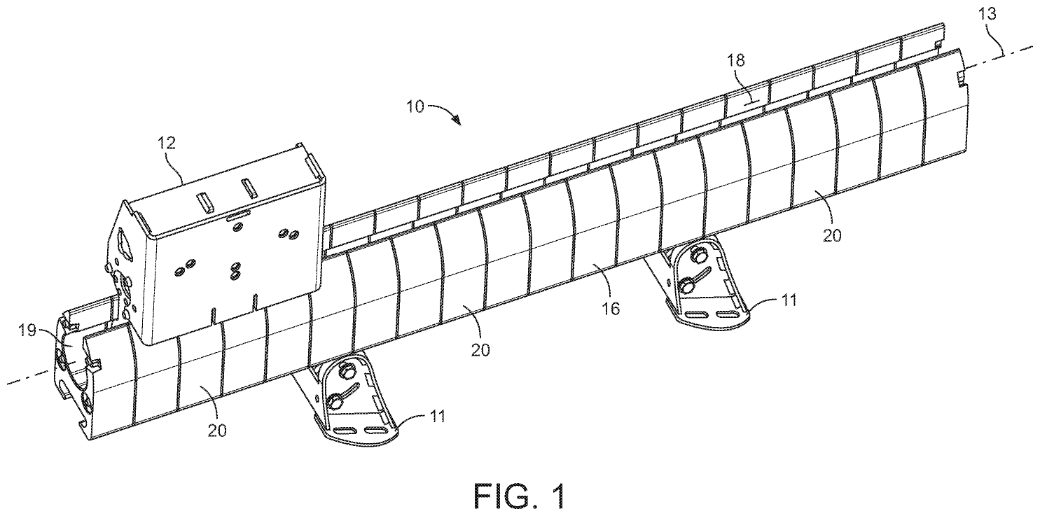

### DETAILED DESCRIPTION OF WORKING EMBODIMENT

The present invention relates to a stairlift of a type commonly installed in homes to provide people with impaired mobility a means to allow them to access different levels in the home with relative ease. Whilst it is conceivable that embodiments of the invention could be adapted for movement along a curved stairlift rail, the embodiment described herein is configured in the form of a straight stairlift. That is to say, a stairlift in which the length axis of the rail is at a single angle of inclination and does not depart laterally from the length axis.

In the example shown the stairlift includes a rail 10 which, in use, is fixed to a staircase by feet 11. A carriage 12 is mounted on the rail 10 for movement up and down the rail. In use, a chair (not shown) or other form of load carrier is mounted on the carriage.

The rail 10 has a longitudinal axis 13 and, when viewed along axis 13 as in FIG. 3, it can be seen that the rail is preferably of constant cross section. In the mounted position the rail shown has a base 15, opposed sides 16, and an upper plane 17 which is largely defined by aperture 18 extending the length of the rail. The aperture 18 provides access to an internal cavity 19 which, in the form shown, has a part circular wall when viewed along axis 13 as in FIG. 3.

The aperture 18 preferably provides the sole access to cavity 19 and, while it is shown in this example extending along the upper boundary of the rail, it could extend along another surface of the rail.

The rail 10 shown in the drawings may be formed from a plurality of rail segments 20 held and preferably clamped together in series along axis 13 by tie rods 21. The segments are conveniently identical and, in combination, provide the rail features described above. The rail segments, which could be injection moulded in a plastics material, further combine to provide a halfen channel 22 into which the feet 11 may be mounted and, thereafter, positioned at any desired position along the base 15 of the rail. The resulting rail could be provided with a lining in the form of an extrusion, preferably an aluminium extrusion, to overlie the joints between the segments 20 and provide a smooth uninterrupted drive surface.

While the rail is shown formed from relatively short, identical, components, those skilled in the art will appreciate that the rail could be formed from more conventional lengths of extruded material, preferably aluminium.

In the depicted example the carriage 12 is driven along the rail 10 by a drive that is preferably housed substantially within the confines of the rail cavity 19 and that part of the carriage that overlies the aperture 18 when viewed in plan view. Further, the drive and the cavity are preferably configured so that the engagement of the drive within the cavity locates the carriage relative to the rail and maintains the carriage in engagement with the rail. To this end the drive may comprise a worm screw 25 forming part of the carriage which engages drive transfer elements 26 fixed to the rail. The worm screw 25, which may be formed from any suitable material including acetal plastics sold under the trade mark Delrin®, is rotatably supported between spaced brackets 27 projecting downwardly from the carriage 12, the brackets being of a width that allows access to cavity 19 through aperture 18. It can be seen in FIG. 3 that the diameter of the worm screw 25 is a close but rotating fit within the cavity 19 and thus the drive retains the carriage on the rail and provides drive for the carriage along the rail.

Drive motor 30 housed within the carriage drives the screw 25 through belt 31 although other forms of transmission could, of course, be used. Further, two drive motors could be employed, one motor applying drive, as shown, to one end of the worm screw 25 and the other (not shown) applying drive to the opposite end of worm screw 25. Such a dual motor system would provide a degree of redundancy in the drive, enhance safety in the event of a failure in one of the drives, and offer the possibility of using smaller motors.

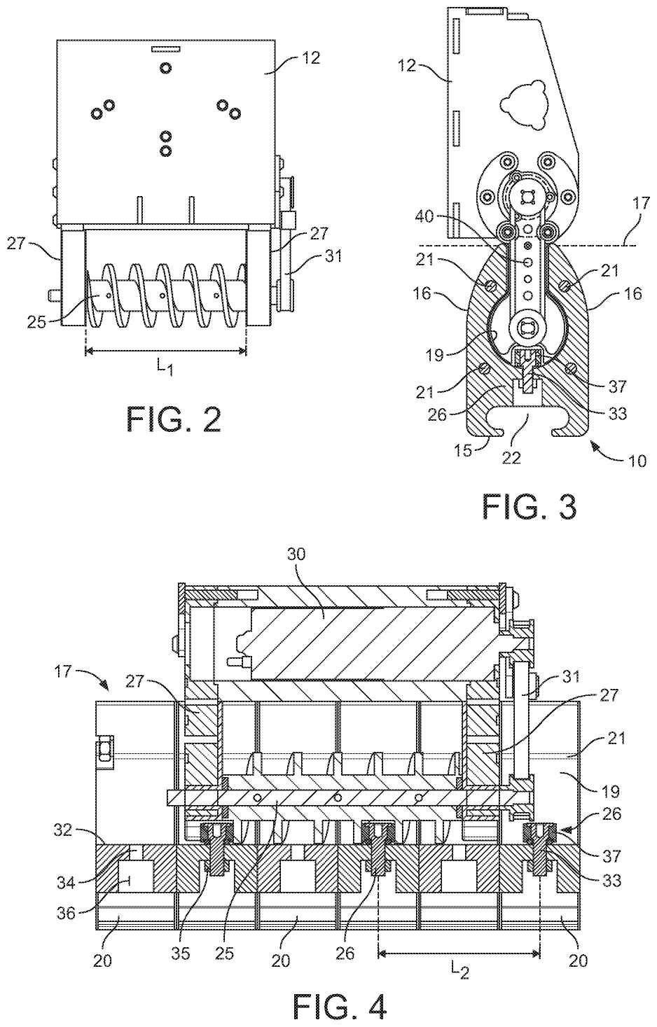

The drive transfer elements 26 are conveniently identical and preferably comprise spigots fixed to an inner surface of the cavity 19 and, more preferably spaced in a line along the base 32 of the cavity. In the form shown each spigot 26 has a mounting shaft 33 which is passed through a hole 34 in the base of the cavity 19 and is fixed therein by a nut or the like 35 housed in bore 36. As can be seen in FIG. 4, not every rail segment 20 need mount a drive spigot 26, spigots 26 being mounted as required by the spacing that needs to be accommodated. More particularly, the length of the screw is indicated by ‘L₁’ in FIG. 2 while the longitudinal spacing between adjacent spigots is indicated by ‘L₂’ in FIG. 4. L1 & L2 are configured or selected with respect to one another so that at least two spigots 26 are engaged by the worm screw 25 at any position of the carriage along the rail.

Each spigot 26 preferably has mounted on its upper end a bearing 37 configured to fit within the drive surfaces of the worm screw 25 and further configured to rotate about the axis of mounting shaft 33 although the ability to rotate is not essential. This ensures that frictional interaction between the screw 25 and the drive transfer elements is kept low giving high drive efficiency.

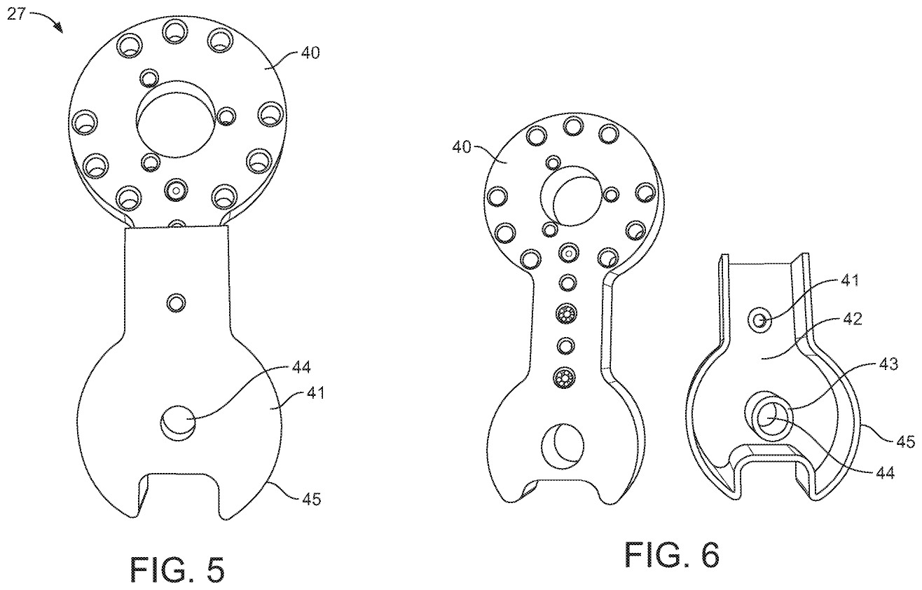

Turning now to FIGS. 5 and 6, as described above the worm screw 25 is mounted for rotation between end brackets 27, each end bracket 27 comprising a downwardly extending pillar 40 over the lower part of which is fitted an end cap 41. In the form shown the pillar is formed from a metal such as, for example, aluminium while the end cap, which is preferably fixed to the inner face of pillar 40, is formed from a plastics material such as Delrin® and may serve three functions. Firstly, integrally formed with the end cap 41, and projecting from the inner surface 42 as shown in FIG. 6, is a boss 43 formed with a through-bore 44. When the brackets 27 are mounted to the carriage, the bores 44 are aligned and serve to mount the worm screw 25. Secondly, the outer peripheral surfaces 45 of the end caps combine to provide sliding clearance with the inner surface of cavity 19 and thus provide vertical support for the carriage with respect to the rail. Thirdly, the end caps may be configured to provide surfaces to resist the horizontal thrust forces arising from the rotation of screw 25.

While in the described example the carriage is supported within the rail on sliding surfaces, those skilled in the art will appreciate that the sliding surfaces could be replaced by, or supplemented with, a suitable arrangement of rollers.

In other respects a stairlift according to the invention has features not shown in the drawings that are common to a straight stairlift including a chair mounted on carriage and suitable controls and safety features to enable the stairlift to be operated in a safe and efficient manner.

1. A stairlift comprising:
a rail having a length direction;
a carriage mounted on said rail for movement along said rail in said length direction;
a chair or load carrier mounted on said carriage; and
a drive mechanism comprising inter-engaging drive elements on said carriage and rail respectively configured and operable to drive said carriage along said rail;
wherein said rail has an internal cavity extending along said length direction axis; an aperture extending along said rail providing access to said cavity, said carriage overlying part of said aperture and projecting through said aperture such that said drive elements are located entirely within said cavity.

2. The stairlift according to claim 1, wherein the rail is configured such that said aperture provides sole means of access to said cavity.

3. The stairlift according to claim 1, wherein said aperture is located at an upper margin of said rail when the stairlift is in an operating state.

4. The stairlift according to claim 3, wherein said rail has a base and sides extending upwardly from said base, said aperture being defined between upper edges of said sides.

5. The stairlift as claimed in according to claim 1, wherein said aperture has a length dimension extending along the length direction of said rail, and a width dimension, said carriage having a width dimension greater than the width dimension of said aperture and overlying part of said aperture.

6. The stairlift according to claim 1, wherein said drive mechanism is configured to retain said carriage on said rail.

7. The stairlift according to claim 1, wherein said drive mechanism comprises:
a worm screw mounted on said carriage and arranged for rotation about an axis parallel to the length direction of said rail; and
drive transfer elements fixed to said rail and extending into said cavity to engage said worm screw.

8. The stairlift according to claim 7, wherein said drive transfer elements are arranged in a line along a base of said cavity.

9. The stairlift according to claim 7, wherein said worm screw has an axial length L₁ and the spacing between adjacent drive transfer elements is a substantially constant L₂ wherein L₂ is less than L₁.

10. The stairlift according to claim 7, wherein, when viewed in a vertical cross-section along said length direction, said worm screw has a circular periphery and said cavity, at least in part, is defined by a circular wall within said rail, clearance being provided between said circular wall and said worm screw.

11. The stairlift according to claim 7, wherein at least some of said drive transfer elements include a bearing engagable with said worm screw and arranged to rotate about an axis perpendicular to an axis of rotation of said worm screw.

12. The stairlift according to claim 7, wherein said worm screw is rotatably supported between end caps, said end caps being further configured to provide sliding support for said carriage within said rail.

13. The stairlift according to claim 7, wherein said worm screw is formed from a plastics material.

14. The stairlift according to claim 1, wherein said rail is defined by a plurality of rail segments held together in series along said length direction.

15. The stairlift according to claim 14, wherein each of said rail segments is substantially identical.
